(19) United States
(12) Patent Application Publication
(10) Pub. No.: US 2014/0344183 A1
(43) Pub. Date: Nov. 20, 2014

(54) LATENT FEATURE MODELS ESTIMATION DEVICE, METHOD, AND PROGRAM

(71) Applicant: Nec Corporation, Tokyo (JP)

(72) Inventors: Ryohei FUJIMAKI, Minato-ku (JP); Kouhei HAYASHI, Minato-ku (JP)

(73) Assignee: NEC CORPORATION, Tokyo (JP)

(21) Appl. No.: 13/898,118

(22) Filed: May 20, 2013

(51) Int. Cl. G06Q 10/06

(52) U.S. Cl. CPC G06Q 10/067
USPC 705/348

(57) ABSTRACT

An approximate computation unit computes an approximate of a determinant of a Hessian matrix relating to observed data represented as a matrix. A variational probability computation unit computes a variational probability of a latent variable using the approximate of the determinant. A latent state removal unit removes a latent state based on a variational distribution. A parameter optimization unit optimizes a parameter for a criterion value that is defined as a lower bound of an approximate obtained by Laplace-approximating a marginal log-likelihood function with respect to an estimator for a complete variable, and computes the criterion value. A convergence determination unit determines whether or not the criterion value has converged.

### BACKGROUND OF THE INVENTION

1. Field of the Invention

The present invention relates to a latent feature models estimation device, a latent feature models estimation method, and a latent feature models estimation program for estimating latent feature models of multivariate data, and especially relates to a latent feature models estimation device, a latent feature models estimation method, and a latent feature models estimation program for estimating latent feature models of multivariate data by approximating model posterior probabilities and maximizing their lower bounds.

2. Description of the Related Art

There are unobserved states (e.g. car trouble states, lifestyles, next day weather conditions) behind data exemplified by sensor data acquired from cars, medical examination value records, electricity demand records, and the like. To analyze such data, latent variable models that assume the existence of unobserved variables play an important role. Latent variables represent factors that significantly influence the above-mentioned observations. Data analysis using latent variable models is applied to many industrially important fields. For example, by analyzing sensor data acquired from cars, it is possible to analyze causes of car troubles and effect quick repairs. Moreover, by analyzing medical examination values, it is possible to estimate disease risks and prevent diseases. Furthermore, by analyzing electricity demand records, it is possible to predict electricity demand and prepare for an excess or shortage.

Mixture distribution models are the most typical example of latent variable models. Mixture distribution models are models which assume that observed data is observed independently from groups having a plurality of properties and represent group structures as latent variables. Mixture distribution models are based on an assumption that each group is independent. However, real data is often observed with entanglement of a plurality of factors. Accordingly, latent feature models which extend mixture distribution models are proposed (for example, see Non-Patent Document 1). Latent feature models assume the existence of a plurality of factors (features) behind each piece of observed data, and are based on an assumption that observations are obtained from combinations of these factors.

To learn latent feature models, it is necessary to determine the number of latent states, the type of observation probability distribution, and distribution parameters. In particular, the problem of determining the number of latent states or the type of observation probability is commonly referred to as “model selection problem” or “system identification problem”, and is an extremely important problem for constructing reliable models. Various techniques for this are proposed.

As a method for determining latent states, for example, a method of maximizing variational free energy by a variational Bayesian method is proposed in Non-Patent Document 1. This method is hereafter referred to as the first known technique.

As another method for determining latent states, for example, a nonparametric Bayesian method using a hierarchical Dirichlet process prior distribution is proposed in Non-Patent Document 1. This method is hereafter referred to as the second known technique.

In mixture models, latent variables are independent, and parameters are independent of latent variables. In hidden Markov models, latent variables have time dependence, and parameters are independent of latent variables. As a technique applied to mixture models and hidden Markov models, a technique called factorized asymptotic Bayesian inference is proposed in Non-Patent Document 2 and Non-Patent Document 3. This technique is superior to the variational Bayesian method and the nonparametric Bayesian method, in terms of speed and accuracy.

In addition, approximating a complete marginal likelihood function and maximizing its lower bound is described in Non-Patent Document 2 and Non-Patent Document 3.

### CITATION LIST

### Non Patent Literature

Non-Patent Document 1: Thomas L. Griffiths and Zoubin Ghahramani, “Infinite Latent Feature Models and the Indian Buffet Process”, Technical Report 2005-001, Gatsby Computational Neuroscience Unit, 2005.
Non-Patent Document 2: Ryohei Fujimaki, Satoshi Morinaga, “Factorized Asymptotic Bayesian Inference for Mixture Modeling”, Proceedings of the fifteenth international conference on Artificial Intelligence and Statistics (AISTATS), 2012.
Non-Patent Document 3: Ryohei Fujimaki, Kohei Hayashi, “Factorized Asymptotic Bayesian Hidden Markov Models”, Proceedings of the 25th international conference on machine learning (ICML), 2012.

### SUMMARY OF THE INVENTION

An exemplary object of the present invention is to provide a latent feature models estimation device, a latent feature models estimation method, and a latent feature models estimation program for solving the model selection problem for latent feature models based on factorized asymptotic Bayesian inference.

An exemplary aspect of the present invention is a latent feature models estimation device including: an approximate computation unit for computing an approximate of a determinant of a Hessian matrix relating to observed data represented as a matrix; a variational probability computation unit for computing a variational probability of a latent variable using the approximate of the determinant; a latent state removal unit for removing a latent state based on a variational distribution; a parameter optimization unit for optimizing a parameter for a criterion value that is defined as a lower bound of an approximate obtained by Laplace-approximating a marginal log-likelihood function with respect to an estimator for a complete variable, and computing the criterion value; and a convergence determination unit for determining whether or not the criterion value has converged.

An exemplary aspect of the present invention is a latent feature models estimation method including: computing an approximate of a determinant of a Hessian matrix relating to observed data represented as a matrix; computing a variational probability of a latent variable using the approximate of the determinant; removing a latent state based on a variational distribution; optimizing a parameter for a criterion value that is defined as a lower bound of an approximate obtained by Laplace-approximating a marginal log-likelihood function with respect to an estimator for a complete variable; computing the approximate of the determinant of the Hessian matrix; computing the criterion value; and determining whether or not the criterion value has converged.

An exemplary aspect of the present invention is a computer readable recording medium having recorded thereon a latent feature models estimation program for causing a computer to execute: an approximate computation process of computing an approximate of a determinant of a Hessian matrix relating to observed data represented as a matrix; a variational probability computation process of computing a variational probability of a latent variable using the approximate of the determinant; a latent state removal process of removing a latent state based on a variational distribution; a parameter optimization process of optimizing a parameter for a criterion value that is defined as a lower bound of an approximate obtained by Laplace-approximating a marginal log-likelihood function with respect to an estimator for a complete variable; a criterion value computation process of computing the criterion value; and a convergence determination process of determining whether or not the criterion value has converged.

### BRIEF DESCRIPTION OF THE DRAWINGS

FIG. 1 is a block diagram showing a structure example of a latent feature models estimation device according to the present invention.

FIG. 2 is a flowchart showing an example of a process according to the present invention.

FIG. 3 is a block diagram showing an overview of the present invention.

### DESCRIPTION OF THE PREFERRED EMBODIMENTS

To clarify the contributions of the present invention, latent feature models and the problem of why factorized asymptotic Bayesian inference cannot be directly applied to latent feature models are described in detail first.

In the following description, let X be observed data. X is represented as a matrix of N rows and D columns, where N is the number of samples and D is the number of dimensions. The element at the n-th row and the d-th column of the matrix is indicated by the subscript nd. For example, the n-th row and the d-th column of X is Xnd.

In latent feature models, it is assumed that X is represented as a product of two matrices (denoted by A and Z). That is, X=ZA+E, where E is an additive noise term. Here, A (whose size is K×D) is a weight parameter that takes a continuous value. Z is a latent variable (whose size is N×K) that takes a binary value. K denotes the number of latent states. In the following description, it is assumed that E is normally distributed. Note, however, that the same argument also applies to wider distribution classes such as an exponential family.

Consider a joint probability distribution for X and Z. The joint distribution is decomposed as shown in the following Expression 1.

p(X,Z|θ)=p(X|Z,θx)p(Z|θz) (Expression 1).

Here, θ is the parameter of the joint distribution, and θx and θz are the parameters of the respective distributions. In the case of assuming that the additive noise term E is independently normally distributed, θx is A and covariance matrix Σx=σx̂2 I, and p(X|Z, θx) is a normal distribution with mean ZA and covariance matrix Σx. I is a unit matrix. Here, Xnd is normally distributed with mean Σ_k Znk Akd and variance σd̂2. The important point is that the parameter A is mutually dependent on the index k of the latent variable.

For comparison, an example of a mixture distribution is described below. In the mixture distribution, the distribution of Xn is represented as p(Xn|Zn, θx)=Π_k (a_k pk(Xn|θk))^{Znk}. Here, a_k is the mixture ratio. pk is the distribution corresponding to the k-th latent variable, and θk is its parameter. It can be understood that the parameter θk is mutually independent of the index k of the latent variable in the mixture distribution, unlike latent feature models.

This problem of parameter dependence is described below, using Non-Patent Document 2 as an example. In Non-Patent Document 2, the joint distribution of the observed variable and the latent variable is Laplace-approximated, and the joint log-likelihood function is approximated. Expression (5) in Non-Patent Document 2 is the approximate equation. The important point is that, when the latent variable is given, the second-order differential matrix (hereafter simply referred to as Hessian matrix) of the log-likelihood function is block diagonal. In other words, the important point is that all off-diagonal blocks of the Hessian matrix are 0 in the case where the parameter corresponding to each latent variable is dependent on the same latent variable but independent of different latent variables. According to this property, pk(Xn|θk) is separately Laplace-approximated for k, each factorized information criterion (Expression (10) in Non-Patent Document 2) is derived, and a factorized asymptotic Bayesian inference algorithm which is an algorithm for maximizing its lower bound is derived (see Section 4 in Non-Patent Document 2). In latent feature models, however, the Hessian matrix is not block diagonal because parameters are dependent on latent variables, as mentioned earlier. This causes the problem that the procedure of factorized asymptotic Bayesian inference cannot be directly applied to latent feature models. The present invention is substantially different from the above-mentioned prior art techniques in that it solves the problem by introducing a Hessian matrix (its determinant) approximation procedure different from the known techniques.

The following describes an embodiment of the present invention with reference to drawings.

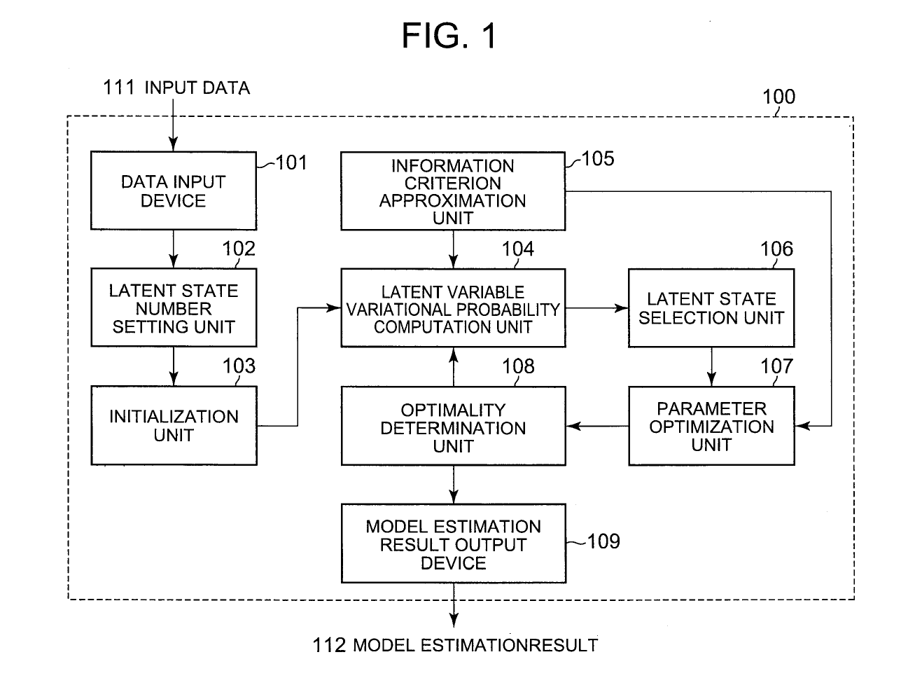

FIG. 1 is a block diagram showing a structure example of a latent feature models estimation device according to the present invention. A latent feature models estimation device 100 according to the present invention includes a data input device 101, a latent state number setting unit 102, an initialization unit 103, a latent variable variational probability computation unit 104, an information criterion approximation unit 105, a latent state selection unit 106, a parameter optimization unit 107, an optimality determination unit 108, and a model estimation result output device 109. Input data 111 is input to the latent feature models estimation device 100. The latent feature models estimation device 100 optimizes latent feature models for the input data 111 and outputs the result as a model estimation result 112.

The data input device 101 is a device for inputting the input data 111. The parameters necessary for model estimation, such as the type of observation probability and the candidate value for the number of latent states, are simultaneously input to the data input device 101 as the input data 111.

The latent state number setting unit 102 sets the number K of latent states of the model, to a maximum value Kmax input as the input data 111. That is, the latent state number setting unit 102 sets K=Kmax.

The initialization unit 103 performs an initialization process for estimation. The initialization may be executed by an arbitrary method. Examples of the method include: a method of randomly setting the parameter θ of each observation probability; and a method of randomly setting the variational probability of the latent variable.

The latent variable variational probability computation unit 104 computes the variational probability of the latent variable. Since the parameter θ has been computed by the initialization unit 103 or the parameter optimization unit 107, the latent variable variational probability computation unit 104 uses the computed value. The latent variable variational probability computation unit 104 computes the variational probability, by maximizing an optimization criterion A defined as follows. The optimization criterion A is defined as a lower bound of an approximate obtained by Laplace-approximating a marginal log-likelihood function with respect to an estimator (e.g. maximum likelihood estimator or maximum posterior probability estimator) for a complete variable.

The information criterion approximation unit 105 performs an approximation process of the determinant of the Hessian matrix, which is necessary for the latent variable variational probability computation unit 104 and the parameter optimization unit 107. The specific process by the information criterion approximation unit 105 is described below.

The following describes the processes by the latent variable variational probability computation unit 104 and the information criterion approximation unit 105 in detail.

In the present invention, the model and parameters are optimized by maximizing the marginal log-likelihood according to Bayesian inference. Here, since it is difficult to directly optimize the marginal log-likelihood, the marginal log-likelihood is first modified as shown in the following Expression 2.

log p(X|M)=max_{—}q Σz q(Z)log p(X,Z|M)/q(Z) (Expression 2).

Here, M is the model, and q(Z) is the variational distribution for Z. Moreover, max_q denotes the maximum value for q. The joint marginal likelihood p(X, Z|M) can be modified as shown in the following Expression 3, in integral form for parameters.

[Math. 1]

p(X,Z|M)=∫p(X,Z|θ)p(θ|M)dθ (Expression 3)

First, consider the joint distribution p(X, Z|θ)=p(Z|θz) p(X|Z, θx)=p(Z|θz) Πk pk(Xn|θk)^{Znk} of mixture distribution models. It should be noted here that p(X|Z, θx)=Πk pk(Xn|θk)^{Znk}. The Hessian matrix for log p(X, Z|θ) is block diagonal with respect to θz and θk (k=1, . . . , K). Accordingly, by Taylor-expanding log p(X, Z|θ) around the maximum likelihood estimator of p(X, Z|θ) and ignoring terms of third or higher order, log p(X, Z|θ) is approximated as shown in the following Expression 4.

$$\begin{matrix} [ Math . 2 ] & \\ log p ( X , Z \vert θ ) \approx log p ( X , Z \vert {θ}^{′} ) - 0.5 N ( θ z - θ {z}^{′} ) Fz ( θ z - θ {z}^{′} ) - Σ k 0.5 ( Σ nZnk ) ( θ k - θ {k}^{′} ) Fk ( θ k - θ {k}^{′} ) & ( Expression 4 )\end{matrix}$$

This expression corresponds to Expression (5) in Non-Patent Document 2. Here, Fz and Fk are respectively matrices obtained by dividing the Hessian matrices of p(Z|θz) and pk(Xn|θk) by N and 5(Σn Znk), and correspond to the block diagonal term of the Hessian matrix of p(X, Z|θ). As a result of substituting the approximation of Expression 4 into Expression 3, the following Expression 5 is obtained as the approximate equation of log p(X, Z|M).

$$\begin{matrix} [ Math . 3 ] & \\ log p ( X , Z \vert M ) \approx log p ( X , Z \vert {θ}^{′} ) + 0.5 ( Dz log 2 π - Dz log N - log det ( Fz ) ) + Σ k 0.5 ( Dk log 2 π - Dk log ( Σ nZnk ) - log det ( Fk ) ) & ( Expression 5 )\end{matrix}$$

This expression corresponds to Expression (9) in Non-Patent Document 2. Here, det denotes the determinant of the argument, and Dz and Dk respectively denote the dimensions of θz and θk. When taking the limit of N into consideration, log 2π, log det(Fz), and log det(Fk) are relatively small and so can be ignored. As a result of substituting into Expression 1 and ignoring the terms relating to them from Expression 5, the following Expression 6 is obtained as the factorized information criterion.

Information criterion=max_{—}q Σz q(Z)(log p(X,Z|θ′)−0.5 Dz log N+Σk 0.5 Dk log(Σn Znk)−log q(Z)) (Expression 6).

log p(X, Z|θ′) represents fitting to data, and Dk log(Σn Znk) represents model complexity.

In factorized asymptotic Bayesian inference proposed in Non-Patent Document 2, θ′ is replaced with arbitrary θ and log(Σn Znk) is replaced with the lower bound where log(Σn Znk)≧log(Σn q′nk)+(Σn Znk−Σn q′nk)/(Σn q′nk), thus estimating the model as shown in the following Expression 7.

M*=argmax_{—}M max_{—}{q,θ,q′}Σz q(Z)(log p(X,Z|θ)−0.5 Dz log N+Σk 0.5 Dk(log(Σn q′nk)+(Σn Znk−Σn q′nk)/(Σn q′nk))−log q(Z)) (Expression 7)

where M* is the estimated optimal model.

The following describes an example of applying the above-mentioned procedure to latent feature models. Regarding the joint distribution p(X, Z|θ)=p(Z|θz) p(X|Z, θx)=p(Z|θz) ΠdΠn p(Xnd|Σ_k Znk Akd, σd̂2) for latent feature models, by Taylor-expanding log p(X, Z|θ) around the maximum likelihood estimator and ignoring terms of third or higher order, the approximate equation shown in the following Expression 8 is obtained.

$$\begin{matrix} [ Math . 4 ] & \\ log p ( X , Z \vert θ ) \approx log p ( X , Z \vert {θ}^{′} ) - 0.5 N ( θ z - θ {z}^{′} ) Fz ( θ z - θ {z}^{′} ) - Σ d 0.5 N ( θ d - θ {d}^{′} ) Fd ( θ d - θ {d}^{′} ) & ( Expression 8 )\end{matrix}$$

Here, θd=(A1d, . . . , AKd, σd), and Fd is the Hessian matrix for θd of log(Πn p(Xnd|Σ_k Znk Akd, σd̂2)).

According to the procedure of the existing technique mentioned above, the following Expression 9 is obtained. That is, as a result of substituting Expression 8 into Expression 3 and ignoring log 2π, log det(Fz), and log det(Fd) as being relatively small, the following Expression 9 is obtained as the approximation of p(X,Z|M).

$$\begin{matrix} [ Math . 5 ] & \\ log p ( X , Z \vert M ) \approx log p ( X , Z \vert {θ}^{′} ) + 0.5 ( Dz log 2 π - Dz log N - log det ( Fz ) ) + Σ d 0.5 ( Dd log 2 π - Dd log N - log det ( Fd ) ) & ( Expression 9 )\end{matrix}$$

Here, Dd=K+1 is the number of dimensions of θd. The information criterion is represented as shown in the following Expression 10.

Information criterion=max_{—}q Σz q(Z)(log p(X,Z|θ′)−0.5 Dz log N+Σd 0.5 Dd log N−log q(Z)) (Expression 10).

The substantial difference between the model estimation process of Expression 6 and the model estimation process of Expression 10 is that the term “0.5 Dk log(Σn Znk)” in Expression 6 is “Dd log N” in Expression 10 where the model complexity does not depend on latent variables. This is described in more detail below. Factorized asymptotic Bayesian inference proposed in Non-Patent Document 2 has the theoretically excellent property such as removal of unwanted latent states and model identifiability, because the model complexity depends on latent variables. Note that removal of unwanted latent states is explained in “Section 4.4 Shrinkage Mechanism” in Non-Patent Document 2, and model identifiability is explained in “Section 4.5 Identifiability” in Non-Patent Document 2. However, such property is lost in Expression 10 obtained for latent feature models as described above.

In view of this, the latent variable variational probability computation unit 104 and the information criterion approximation unit 105 proposed in the present invention compute the information criterion according to the procedure described below.

In the procedure in Non-Patent Document 2, log det(Fd) in Expression 9 is, as being asymptotically small, approximated as follows.

[Math. 6]

log det(Fd)≠0

On the other hand, the information criterion approximation unit 105 approximates log det(Fd) as shown in the following Expression 11.

[Math. 7]

log det(Fd)≠Σk log(Σn Znk)−K log N (Expression 11)

As a result of substituting Expression 11 into Expression 9 and ignoring log 2π and log det(Fz) as being asymptotically small, Expression 12 is obtained as the information criterion, instead of Expression 10.

Information criterion=max_{—}q Σz q(Z)(log p(X,Z|θ′)−0.5 Dz log N+Σd 0.5 Dd log(Σn Znd)−log q(Z)) (Expression 12).

Expression 12 has the same form as Expression 6. According to Expression 12, the criterion provides the theoretically excellent property such as removal of unwanted latent states and model identifiability, because the model complexity depends on latent variables. The important point is that the process by the information criterion approximation unit 105 (i.e. the approximation of Expression 11) is essential in order to obtain the criterion of Expression 12 for latent feature models. This is a characteristic feature of the present invention, which is absent from the known techniques.

The latent state selection unit 106 removes small states of latent states, from the model. In detail, in the case where, for the k-th latent state, Σn q(Znk) is below a threshold set as the input data 111, the latent state selection unit 106 removes the state from the model.

The parameter optimization unit 107 optimizes θ for the optimization criterion A, after fixing the variational probability of the latent variable. Note that the term relating to θ of the optimization criterion A is a joint log-likelihood function weighted by the variational distribution of latent states, and can be optimized according to an arbitrary optimization algorithm. For instance, in the normal distribution in the above-mentioned example, the parameter optimization unit 107 can optimize the parameter according to mean field approximation. In addition, the parameter optimization unit 107 simultaneously computes the optimization criterion A for the optimized parameter. When doing so, the parameter optimization unit 107 uses the approximate computation by the information criterion approximation unit 105 mentioned above. That is, the parameter optimization unit 107 uses the approximation result of the determinant of the Hessian matrix by Expression 11.

The optimality determination unit 108 determines the convergence of the optimization criterion A. The convergence can be determined by setting a threshold for the amount of absolute change or relative change of the optimization criterion A and using the threshold.

The model estimation result output device 109 outputs the optimal number of latent states, observation probability parameter, variational distribution, and the like, as the model estimation result output result 112.

The latent state number setting unit 102, the initialization unit 103, the latent variable variational probability computation unit 104, the information criterion approximation unit 105, the latent state selection unit 106, the parameter optimization unit 107, and the optimality determination unit 108 are realized, for example, by a CPU of a computer operating according to a latent feature models estimation program. In this case, the CPU may read the latent feature models estimation program and, according to the program, operate as the latent state number setting unit 102, the initialization unit 103, the latent variable variational probability computation unit 104, the information criterion approximation unit 105, the latent state selection unit 106, the parameter optimization unit 107, and the optimality determination unit 108. The latent feature models estimation program may be stored in a computer readable recording medium. Alternatively, each of the above-mentioned components 102 to 108 may be realized by separate hardware.

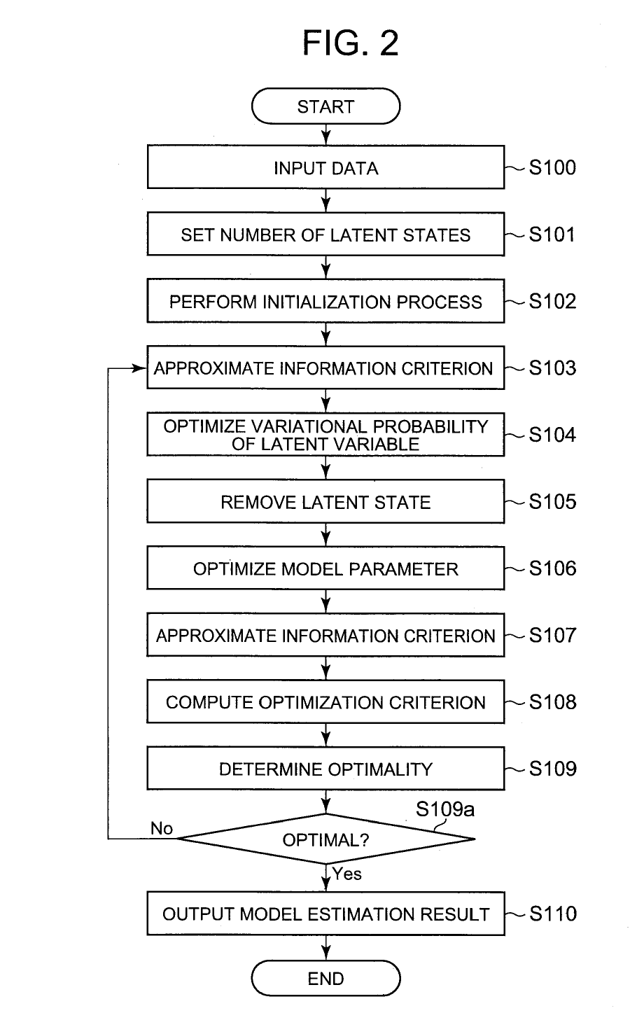

FIG. 2 is a flowchart showing an example of a process according to the present invention. The input data 111 is input via the data input device 101 (step S100).

Next, the latent state number setting unit 102 sets the maximum value of the number of latent states input as the input data 111, as the initial value of the number of latent states (step S101). That is, the latent state number setting unit 102 sets the number K of latent states of the model, to the input maximum value Kmax.

Next, the initialization unit 103 performs the initialization process of the variational probability of the latent variable and the parameter for estimation (e.g. the parameter θ of each observation probability), for the designated number of latent states (step S102).

Next, the information criterion approximation unit 105 performs the approximation process of the determinant of the Hessian matrix (step S103). The information criterion approximation unit 105 computes the approximate of the determinant of the Hessian matrix through the computation of Expression 11.

Next, the latent variable variational probability computation unit 104 computes the variational probability of the latent variable using the computed approximate of the determinant of the Hessian matrix (step S104).

Next, the latent state selection unit 106 removes any unwanted latent state from the model, based on the above-mentioned threshold determination (step S105). That is, in the case where, for the k-th latent state, Σn q(Znk) is below the threshold set as the input data 111, the latent state selection unit 106 removes the state from the model.

Next, the parameter optimization unit 107 computes the parameter for optimizing the optimization criterion A (step S106). For example, the optimization criterion A used the first time the parameter optimization unit 107 executes step S106 may be randomly set by the initialization unit 103. As an alternative, the initialization unit 103 may randomly set the variational probability of the latent variable, with step S106 being omitted in the first iteration of the loop process of steps S103 to S109a (see FIG. 2).

Next, the information criterion approximation unit 105 performs the approximation process of the determinant of the Hessian matrix (step S107). The information criterion approximation unit 105 computes the approximate of the determinant of the Hessian matrix through the computation of Expression 11.

Next, the parameter optimization unit 107 computes the value of the optimization criterion A, using the parameter optimized in step S106 (step S108).

Next, the optimality determination unit 108 determines whether or not the optimization criterion A has converged (step S109). For example, the optimality determination unit 108 may compute the difference between the optimization criterion A obtained by the most recent iteration of the loop process of steps S103 to S109a and the optimization criterion A obtained by the iteration of the loop process of steps S103 to S109a immediately preceding the most recent iteration, and determine that the optimization criterion A has converged in the case where the absolute value of the difference is less than or equal to a predetermined threshold, and that the optimization criterion A has not converged in the case where the absolute value of the difference is greater than the threshold.

In the case of determining that the optimization criterion A has not converged (step S109a: No), the latent feature models estimation device 100 repeats the process from step S103. In the case of determining that the optimization criterion A has converged (step S109a: Yes), the model estimation result output device 109 outputs the model estimation result, thus completing the process (step S110). In step S110, the model estimation result output device 109 outputs the number of latent states at the time when it is determined that the optimization criterion A has converged, and the parameter and variational distribution obtained at the time.

The following describes an example of application of the latent feature models estimation device proposed in the present invention, using factor analysis of medical examination data as an example. In this example, consider a matrix having medical examinees in the row direction (samples) and medical examination item values such as blood pressure, blood sugar level, and BMI in the column direction (features), as X. The distribution of each examination item value is formed with complex entanglement of not only easily observable factors such as age and sex but also factors difficult to be observed such as lifestyles. Besides, it is difficult to determine the number of factors beforehand. It is desirable that the number of factors can be automatically determined from the data, to avoid arbitrary analysis.

By applying the latent feature models estimation device proposed in the present invention to such data, the variational distribution of latent features for each sample can be estimated while taking the multivariate dependence of each item into consideration.

For example, when analyzing factors for a sample, highly influential factors can be analyzed by setting factors whose expectations in the variational distribution of the sample are greater than 0.5 as “influential” and factors whose expectations are less than 0.5 as “not influential”. Furthermore, according to the present invention, the number of latent features can be appropriately determined in the context of marginal likelihood maximization, based on the framework of factorized asymptotic Bayesian inference. For example, in factor analysis by principal component analysis, variables which are the most characteristic of observed variables are treated as factors. According to the present invention, the significant effect that unobserved factors can be automatically found from data can be achieved.

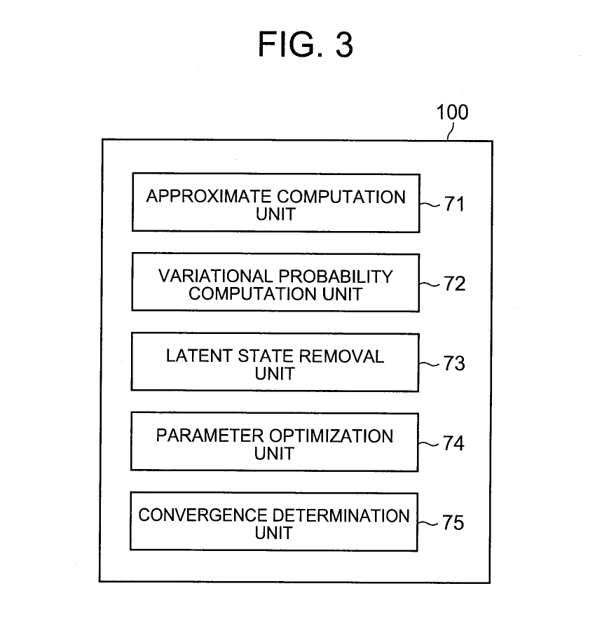

The following describes an overview of the present invention. FIG. 3 is a block diagram showing the overview of the present invention. The latent feature models estimation device 100 according to the present invention includes an approximate computation unit 71, a variational probability computation unit 72, a latent state removal unit 73, a parameter optimization unit 74, and a convergence determination unit 75.

The approximate computation unit 71 (e.g. the information criterion approximation unit 105) computes an approximate of a determinant of a Hessian matrix relating to observed data represented as a matrix (e.g. performs the approximate computation of Expression 11).

The variational probability computation unit 72 (e.g. the latent variable variational probability computation unit 104) computes a variational probability of a latent variable using the approximate of the determinant.

The latent state removal unit 73 (e.g. the latent state selection unit 106) removes a latent state based on a variational distribution.

The parameter optimization unit 74 (e.g. the parameter optimization unit 107) optimizes a parameter for a criterion value (e.g. the optimization criterion A) that is defined as a lower bound of an approximate obtained by Laplace-approximating a marginal log-likelihood function with respect to an estimator for a complete variable, and computes the criterion value.

The convergence determination unit 75 (e.g. the optimality determination unit 108) determines whether or not the criterion value has converged.

Moreover, it is preferable that a loop process in which the approximate computation unit 71 computes the approximate of the determinant of the Hessian matrix, the variational probability computation unit 72 computes the variational probability of the latent variable, the latent state removal unit 73 removes the latent state, the parameter optimization unit 74 optimizes the parameter, the approximate computation unit 71 computes the approximate of the determinant of the Hessian matrix, the parameter optimization unit 74 computes the criterion value, and the convergence determination unit 75 determines whether or not the criterion value has converged is repeatedly performed until the convergence determination unit 75 determines that the criterion value has converged.

In the first known technique, the independence of latent states and distribution parameters in the variational distribution is assumed when maximizing the lower bound of the marginal likelihood function. The first known technique therefore has the problem of poor marginal likelihood approximation accuracy.

The second known technique has the problem of extremely high computational complexity due to model complexity, and the problem that the result varies significantly depending on the input parameters.

In the techniques described in Non-Patent Document 2, Non-Patent Document 3, and so on, substantially the independence of parameters with respect to latent variables is important. Therefore, factorized asymptotic Bayesian inference cannot be directly applied to models in which parameters have dependence relations with latent variables, such as latent feature models.

According to the present invention, it is possible to solve the model selection problem for latent feature models based on factorized asymptotic Bayesian inference.

What is claimed is:

1. A latent feature models estimation device comprising:
an approximate computation unit for computing an approximate of a determinant of a Hessian matrix relating to observed data represented as a matrix;
a variational probability computation unit for computing a variational probability of a latent variable using the approximate of the determinant;
a latent state removal unit for removing a latent state based on a variational distribution;
a parameter optimization unit for optimizing a parameter for a criterion value that is defined as a lower bound of an approximate obtained by Laplace-approximating a marginal log-likelihood function with respect to an estimator for a complete variable, and computing the criterion value; and
a convergence determination unit for determining whether or not the criterion value has converged.

2. The latent feature models estimation device according to claim 1, wherein a loop process in which the approximate computation unit computes the approximate of the determinant of the Hessian matrix, the variational probability computation unit computes the variational probability of the latent variable, the latent state removal unit removes the latent state, the parameter optimization unit optimizes the parameter, the approximate computation unit computes the approximate of the determinant of the Hessian matrix, the parameter optimization unit computes the criterion value, and the convergence determination unit determines whether or not the criterion value has converged is repeatedly performed until the convergence determination unit determines that the criterion value has converged.

3. A latent feature models estimation method comprising:
computing an approximate of a determinant of a Hessian matrix relating to observed data represented as a matrix;
computing a variational probability of a latent variable using the approximate of the determinant;
removing a latent state based on a variational distribution;
optimizing a parameter for a criterion value that is defined as a lower bound of an approximate obtained by Laplace-approximating a marginal log-likelihood function with respect to an estimator for a complete variable;
computing the approximate of the determinant of the Hessian matrix;
computing the criterion value; and
determining whether or not the criterion value has converged.

4. The latent feature models estimation method according to claim 3, wherein a loop process of computing the approximate of the determinant of the Hessian matrix, computing the variational probability of the latent variable, removing the latent state, optimizing the parameter, computing the approximate of the determinant of the Hessian matrix, computing the criterion value, and determining whether or not the criterion value has converged is repeatedly performed until the criterion value converges.

5. A computer readable recording medium having recorded thereon a latent feature models estimation program for causing a computer to execute:
an approximate computation process of computing an approximate of a determinant of a Hessian matrix relating to observed data represented as a matrix;
a variational probability computation process of computing a variational probability of a latent variable using the approximate of the determinant;
a latent state removal process of removing a latent state based on a variational distribution;
a parameter optimization process of optimizing a parameter for a criterion value that is defined as a lower bound of an approximate obtained by Laplace-approximating a marginal log-likelihood function with respect to an estimator for a complete variable;
a criterion value computation process of computing the criterion value; and
a convergence determination process of determining whether or not the criterion value has converged.

6. The computer readable recording medium having recorded thereon the latent feature models estimation program according to claim 5 for causing the computer to repeatedly execute a loop process of the approximate computation process, the variational probability computation process, the latent state removal process, the parameter optimization process, the approximate computation process, the criterion value computation process, and the convergence determination process, until the criterion value is determined to have converged.
